(19) United States
(12) Patent Application Publication
(10) Pub. No.: US 2021/0350398 A1
(43) Pub. Date: Nov. 11, 2021

(54) CONTROL METHOD, SERVER, RECORDING MEDIUM, AND DATA STRUCTURE

(71) Applicant: Panasonic Intellectuel Property Corporation of America, Torrance, CA (US)

(72) Inventors: Yuji UNAGAMI, Osaka (JP); Junji MICHIYAMA, Fukuoka (JP); Junichiro SOEDA, Nara (JP); Yuuki HIROSE, Osaka (JP); Tetsuji FUCHIKAMI, Osaka (JP); Motoji OHMORI, Osaka (JP)

(21) Appl. No.: 17/381,459

(22) Filed: Jul. 21, 2021

Related U.S. Application Data
(63) Continuation of application No. PCT/JP2020/004677, filed on Feb. 6, 2020.
(60) Provisional application No. 62/802,851, filed on Feb. 8, 2019.

(51) Int. Cl. G06Q 30/02; G06Q 20/38

(52) U.S. Cl. CPC G06Q 30/0207; G06Q 20/389

(57) ABSTRACT

A control method includes: receiving first transaction data related to a sign-up for crowdfunding from at least one participant and storing the first transaction data received into a distributed ledger which is included in each of the servers and stores beforehand reward information specifying a reward amount that is to be offered for each of the at least one participant and that has a tendency to decrease with a later timing of the sign-up of the at least one participant; determining, by reference to the reward information, the reward amount for each of the at least one participant based on a timing at which the first transaction data is received; and storing, into the distributed ledger, second transaction data indicating that each of the at least one participant is offered the reward amount determined in the determining, if it is determined that a goal condition of the crowdfunding is satisfied.

### CROSS REFERENCE TO RELATED APPLICATIONS

This is a continuation application of PCT International Application No. PCT/JP2020/004677 filed on Feb. 6, 2020, designating the United States of America, which is based on and claims priority of U.S. Provisional Patent Application No. 62/802,851 filed on Feb. 8, 2019. The entire disclosures of the above-identified applications, including the specifications, drawings and claims are incorporated herein by reference in their entirety.

### FIELD

The present disclosure relates to a control method, a server, a recording medium, and a data structure.

### BACKGROUND

An information processing device aimed at encouraging the spread of crowdfunding has been proposed (see Patent Literature (PTL) 1).

### CITATION LIST

### Patent Literature

PTL 1: Japanese Unexamined Patent Application Publication No. 2017-156927

### SUMMARY

### Technical Problem

It may take a relatively long time for crowdfunding to succeed, or the crowdfunding may not succeed before the expiry of a solicitation period of the crowdfunding. In such a case, unfortunately, power consumed by a fund management system to operate during the solicitation period increases.

In view of this, the present disclosure provides a control method and so forth that are capable of reducing power consumption of a fund management system for crowdfunding.

### Solution to Problem

A control method according to an aspect of the present disclosure is a control method executed by one of a plurality of servers included in a fund management system, each of the plurality of servers including a distributed ledger, the control method including: receiving first transaction data that is transaction data related to a sign-up for crowdfunding from at least one participant and storing the first transaction data received into the distributed ledger included in each of the plurality of servers, the distributed ledger storing beforehand reward information specifying a reward amount that is to be offered for each of the at least one participant and that has a tendency to decrease with a later timing of the sign-up of the at least one participant; determining, by reference to the reward information, the reward amount for each of the at least one participant based on a timing at which the first transaction data is received; and storing, into the distributed ledger, second transaction data that is transaction data indicating that each of the at least one participant is offered the reward amount determined in the determining, if it is determined that a goal condition of the crowdfunding is satisfied.

Note that these general and specific aspects may be implemented as a system, a device, an integrated circuit, a computer program, or a computer-readable recording medium such as a CD-ROM, or as any combination of a system, a device, an integrated circuit, a computer program, and a recording medium.

### Advantageous Effects

The control method according to the present disclosure is capable of reducing power consumption of a fund management system for crowdfunding.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic block diagram illustrating a configuration of a fund management system according to Embodiment 1.

FIG. 2 is a schematic block diagram illustrating a configuration of a server according to Embodiment 1.

FIG. 3 illustrates a first example of reward information according to Embodiment 1.

FIG. 4 illustrates a second example of reward information according to Embodiment 1.

FIG. 5 illustrates an example of a recording table of reward amounts according to Embodiment 1.

FIG. 6 schematically illustrates solicitation transaction data according to Embodiment 1.

FIG. 7 schematically illustrates sign-up transaction data according to Embodiment 1.

FIG. 8 schematically illustrates funding transaction data according to Embodiment 1.

FIG. 9 schematically illustrates reward offering transaction data according to Embodiment 1.

FIG. 10 schematically illustrates goal determination transaction data according to Embodiment 1.

FIG. 11 schematically illustrates reward request transaction data according to Embodiment 1.

FIG. 12 is a flowchart illustrating a first case of processing performed by the server according to Embodiment 1.

FIG. 13 is a sequence corresponding to FIG. 12 and illustrates system-wide processing of the fund management system.

FIG. 14 is a flowchart illustrating a second case of processing performed by the server according to Embodiment 1.

FIG. 15 is a sequence corresponding to FIG. 14 and illustrates system-wide processing performed by the fund management system.

FIG. 16 is a flowchart illustrating a third case of processing performed by the server according to Embodiment 1.

FIG. 17 is a sequence corresponding to FIG. 16 and illustrates system-wide processing performed by the fund management system.

FIG. 18 is a flowchart illustrating a fourth case of processing performed by the server according to Embodiment 1.

FIG. 19 is a sequence corresponding to FIG. 18 and illustrates system-wide processing performed by the fund management system.

FIG. 20 illustrates a first example of reward information according to Embodiment 2.

FIG. 21 illustrates a second example of reward information according to Embodiment 2.

FIG. 22 illustrates reward amounts determined by two smart contracts according to Embodiment 2.

FIG. 23 is a sequence of processing executed by the two smart contracts to determine the reward amounts, according to Embodiment 2.

FIG. 24 is a schematic block diagram illustrating a configuration of a fund management system according to Variation 1 of Embodiments.

FIG. 25 is a schematic block diagram illustrating a configuration of a fund management system according to Variation 2 of Embodiments.

FIG. 26 is a flowchart of processing performed by a server according to Variation 3 of Embodiments.

FIG. 27 is a schematic block diagram illustrating a configuration of the server according to Variation 3 of Embodiments.

FIG. 28 illustrates a data structure of a blockchain.

FIG. 29 illustrates a data structure of transaction data.

### DESCRIPTION OF EMBODIMENTS

(Underlying Knowledge Forming Basis of the Present Disclosure)

In relation to the crowdfunding technology in the Background section, the inventors have found the following problem.

Crowdfunding is an Internet-based way of raising a fund for a project (for creating and delivering new content, for example) from at least one individual (also referred to as a supporter) and providing the fund to a content deliverer. This allows the content deliverer to finance the project.

The information processing device aimed at encouraging the spread of crowdfunding has been proposed (see PTL 1). The technology disclosed in PTL 1 may encourage the spread of crowdfunding by holding crowdfunding at a live venue.

However, it may take a relatively long time for crowdfunding to succeed, or the crowdfunding may not succeed even after the expiry of a solicitation period of the crowdfunding. In such a case, unfortunately, power consumed by a fund management system to operate during the solicitation period increases. The fund management system includes at least one server, at least one communication device, and other information devices. Each of these components consumes power to operate.

In response to this, the present disclosure provides a control method and so forth that are capable of reducing power consumption of the fund management system for crowdfunding.

A control method according to an aspect of the present disclosure is a control method executed by one of a plurality of servers included in a fund management system, each of the plurality of servers including a distributed ledger. The control method includes: receiving first transaction data that is transaction data related to a sign-up for crowdfunding from at least one participant and storing the first transaction data received into the distributed ledger included in each of the plurality of servers, the distributed ledger storing beforehand reward information specifying a reward amount that is to be offered for each of the at least one participant and that has a tendency to decrease with a later timing of the sign-up of the at least one participant; determining, by reference to the reward information, the reward amount for each of the at least one participant based on a timing at which the first transaction data is received; and storing, into the distributed ledger, second transaction data that is transaction data indicating that each of the at least one participant is offered the reward amount determined in the determining, if it is determined that a goal condition of the crowdfunding is satisfied.

According to the above aspect, a participant, who intends to obtain the highest possible reward amount, is encouraged to sign up at an earlier timing. This enables the crowdfunding to achieve success sooner. After this early success of the crowdfunding, power consumption for operating the server to manage the crowdfunding can be reduced. Thus, the control method according to the present disclosure is capable of reducing the power consumption of the fund management system for crowdfunding.

Moreover, it is substantially impossible for the transaction data stored in the distributed ledger to be falsified. Thus, the management information related to the procedure for the sign-up or token offering for the crowdfunding is appropriately managed. Hence, the control method according to the aspect of the present disclosure also has an advantageous effect of appropriately managing procedures for crowdfunding.

For example, if the first transaction data is received from one participant among the at least one participant, the determining of the reward amount of the one participant may be performed within a predetermined time period of receiving the first transaction data.

According to the above aspect, the reward amount is determined within the predetermined time period of receiving the sign-up transaction data. This allows the processing timings to be distributed and thereby is useful in distributing a processing load of the server. Moreover, this can avoid a momentary peak of power consumption that may arise. Hence, the control method according to the present disclosure is capable of temporally distributing the processing load and thereby reducing the power consumption of the fund management system for crowdfunding.

For example, the control method may further include: notifying the one participant about the reward amount determined in the determining, within a predetermined time period of receiving the first transaction data.

According to the above aspect, the notification of the reward amount to the participant allows the participant to know the reward to be offered to the participant. This further motivates the participant to newly sign up. Thus, the power consumption for operating the server to manage the crowdfunding can be further reduced. Hence, the control method according to the present disclosure is capable of reducing the power consumption of the fund management system for crowdfunding.

For example, the determining of the reward amount of the at least one participant may be performed after it is determined that the goal condition of the crowdfunding is satisfied.

According to the above aspect, the reward amounts of all the participants are determined after the crowdfunding achieves success. Thus, more appropriate reward amounts can be determined in view of an overall status of the crowdfunding. Hence, the control method according to the present disclosure is capable of reducing the power consumption of the fund management system for crowdfunding.

For example, the reward information may further specify an additional reward amount that is to be additionally offered to a participant, among the at least one participant, that signs up after a predetermined timing within a solicitation period of the crowdfunding, and the control method further may further include: storing, into the distributed ledger, third transaction data that is transaction data indicating that the additional reward amount is to be offered to the participant, among the at least one participant, that signs up after the predetermined timing.

According to the above aspect, the additional reward is offered to the participant. Thus, even after the predetermined timing in the solicitation period, a participant intends to obtain the highest possible reward amount and thus signs up as soon as possible. This further enables the crowdfunding to achieve success even sooner. Thus, the control method according to the present disclosure is capable of further reducing the power consumption of the fund management system for crowdfunding.

For example, the storing of the transaction data into the distributed ledger included in each of the plurality of servers may include storing the transaction data into the distributed ledger through execution of a consensus algorithm by each of the plurality of servers.

According to the above aspect, the distributed ledger is stored through the execution of the consensus algorithm. Hence, the control method according to the present disclosure more easily enables appropriate management of funding for the crowdfunding by the execution of the consensus algorithm.

For example, the determining of the reward amount for each of the at least one participant may be performed using a smart contract that is executed based on the storing of the first transaction data into the distributed ledger.

According to the above aspect, the reward amount is determined early and safely without any intervention of another person or another system. Hence, the control method according to the present disclosure is capable of further reducing the power consumption of the fund management system for crowdfunding.

For example, the determining of the additional reward amount may be performed using a smart contract that is executed based on the storing of the first transaction data into the distributed ledger.

According to the above aspect, the additional reward amount is determined early and safely without any intervention of another person or another system. Hence, the control method according to the present disclosure is capable of further reducing the power consumption of the fund management system for crowdfunding.

Furthermore, a server according to an aspect of the present disclosure is a server among a plurality of servers included in a fund management system, each of the plurality of servers including a distributed ledger. The server includes: a processor that receives first transaction data related to a sign-up for crowdfunding from at least one participant and stores the first transaction data received into the distributed ledger, which is included in each of the plurality of servers and stores beforehand reward information specifying a reward amount that is to be offered for each of the at least one participant and that has a tendency to decrease with a later timing of the sign-up of the at least one participant; and a controller that determines, by reference to the reward information, the reward amount for each of the at least one participant based on a timing at which the first transaction data is received. If it is determined that a goal condition of the crowdfunding is satisfied, the processor further stores, into the distributed ledger, second transaction data that indicates that each of the at least one participant is offered the reward amount determined.

According to the above aspect, the same advantageous effect as in the above control method can be produced.

A recording medium according to an aspect of the present disclosure is a non-transitory computer-readable recording medium having recorded thereon a program for causing a computer to execute the above-described control method.

According to the above aspect, the same advantageous effect as in the above control method can be produced.

Furthermore, a data structure according to an aspect of the present disclosure is a data structure to be recorded into a distributed ledger included in each of a plurality of servers of a fund management system. The data structure includes reward information specifying a reward amount that is to be offered for each of at least one participant who signs up for crowdfunding and that has a tendency to decrease with a later timing of a sign-up of each of the at least one participant. If the at least one participant signs up for the crowdfunding after the data structure is recorded into the distributed ledger, the data structure is used for determining the reward amount to be offered for each of the at least one participant based on the reward information.

According to the above aspect, the same advantageous effect as in the above control method can be produced.

Note that these general and specific aspects may be implemented as a system, a device, an integrated circuit, a computer program, or a computer-readable recording medium such as a CD-ROM, or as any combination of a system, a device, an integrated circuit, a computer program, and a recording medium.

Exemplary embodiments will be described in detail below with reference to the drawings.

Note that each of the embodiments described below shows a generic or specific example. The numerical values, shapes, materials, structural components, the arrangement and connection of the structural components, steps, the processing order of the steps, etc., shown in the following embodiments are mere examples, and thus are not intended to limit the present disclosure. Among the structural components described in the following embodiments, structural components not recited in any one of the independent claims that indicate the broadest concepts will be described as optional structural components.

### Embodiment 1

The present embodiment describes a fund management system and a control method used by the fund management system which are capable of reducing power consumption of the fund management system. Note that a unit of funding is also referred to as a project. A project is assumed to relate to content delivery. The following describes a project where: one who delivers content is referred to as a deliverer; one who solicits funding for the content is referred to as an initiator; and one who signs up to participate in the funding is referred to as a participant. If sign-ups for the funding meet a predetermined goal amount during a solicitation period predetermined for this project, the project is phrased as achieving “success” or being “successful”.

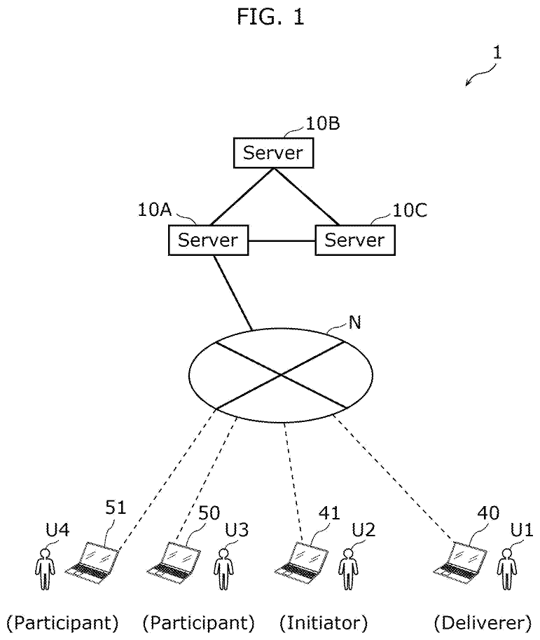

FIG. 1 is a schematic block diagram illustrating a configuration of fund management system 1 according to Embodiment 1.

As illustrated in FIG. 1, fund management system 1 includes servers 10A, 10B, and 10C and terminals 40, 41, 50, and 51. These devices included in fund management system 1 are communicably connected to each other via network N. Network N may use any kind of communication line or network. Examples include the Internet and a mobile phone carrier network. Servers 10A, 10B, and 10C may also referred to as “servers 10A etc.”

Server 10A is one of a plurality of servers 10A, 10B, and 10C that manage crowdfunding performed by fund management system 1. Server 10A is one of the plurality of servers 10A, 10B, and 10C each of which holds a distributed ledger. The distributed ledger held by server 10A stores various kinds of transaction data relating to procedures or processing for crowdfunding (including solicitation, sign-up, end determination, and reward offering). By receiving the transaction data, server 10A receives the procedure or processing for the crowdfunding. Note that the funding for the project is managed as offering of a token in the distributed ledger, as an example. A token refers to value information managed in the distributed ledger. A token corresponds to, or is exchangeable with, money, a gift certificate, or a coupon, for instance.

Each of servers 10B and 10C has the same function as server 10A and operates independently of server 10A. The number of servers is not limited to three and may be at least two. Servers 10A etc. are communicably connected to each other, and may be connected via network N.

The present embodiment describes a case where server 10A, out of servers 10A etc., receives transaction data from terminal 41 for example and transmits a notification to terminal 41 for example. However, the other server (server 10B or 10C) may perform these operations instead.

Terminal 40 is a terminal device owned by a deliverer. Content to be delivered by the deliverer is electronic data, such as a moving image, a still image, music, or software (including application software). The content delivered by the deliverer is assumed to be created by this deliverer. Although the present embodiment describes such a case, this is not intended to be limiting. If the project is successful, terminal 40 delivers the content related to the project to the participant. Terminal 40 is a personal computer, a smartphone, or a tablet, for example.

Terminal 41 is a terminal device owned by an initiator of a crowdfunding project. The initiator solicits funding from participants so that a total of funding received from the participants reaches a goal amount of the project. Note that the initiator may be or may not be the same individual as the deliverer or the participant. To solicit funding, terminal 41 generates transaction data including information about funding solicitation (this data is also referred to as solicitation transaction data) and transmits the generated solicitation transaction data to server 10A for example.

Terminal 50 is a terminal device owned by a participant. The participant signs up for the funding by reference to the information about funding solicitation. After this, if the project is successful, the funds are actually offered to the deliverer through the initiator. Moreover, a reward corresponding to a sign-up timing is offered to the participant from a crowdfunding management account or the deliverer. In contrast, if the project is unsuccessful, no funding is offered to the initiator and the deliverer and no reward is offered.

For sign-up for funding, terminal 50 generates transaction data for sign-up (this data is also referred to as sign-up transaction data or first transaction data) and transmits the generated sign-up transaction data to server 10A. If the project is successful, terminal 50 obtains the content delivered by the deliverer. After this, the participant can use the content.

Terminal 51 is a terminal device owned by a participant who signs up for the funding but is different from the participant owning terminal 50. Terminal 51 has the same function as terminal 50 and operates independently of terminal 50. Note that the number of terminals owned by the participants is not limited to two and that the number of terminals is equal to the number of participants.

The following describes in detail configurations of servers 10A etc. included in fund management system 1.

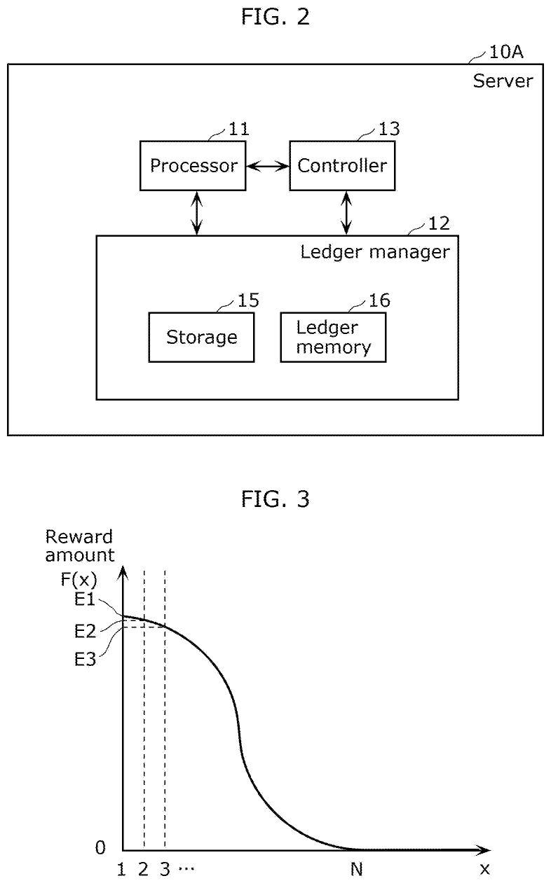

FIG. 2 is a schematic block diagram illustrating a configuration of server 10A according to Embodiment 1.

As illustrated in FIG. 2, server 10A includes processor 11, ledger manager 12, and controller 13. These functional components included in server 10A may be implemented by a central processing unit (CPU) executing a program using a memory, for example.

Processor 11 manages various kinds of information using the distributed ledger. If receiving the transaction data from a device included in fund management system 1 or if obtaining the transaction data generated by controller 13, processor 11 stores the received or obtained transaction data into the distributed ledger by providing this transaction data to ledger manager 12. The transaction data includes solicitation transaction data, sign-up transaction data, funding transaction data, reward offering transaction data, goal determination transaction data, and reward request transaction data. These pieces of transaction data are described in detail below.

Ledger manager 12 is a processor that manages the distributed ledger. Ledger manager 12 stores the transaction data provided by processor 11 into the distributed ledger. The distributed ledger stores the transaction data from past to present. Information recorded in a distributed ledger has characteristics of being less subject to falsification. This allows the aforementioned transaction data to be managed to avoid falsification.

Ledger manager 12 includes storage 15 and ledger memory 16.

Storage 15 is a processor that stores new transaction data, which is to be stored into the distributed ledger, into ledger memory 16. Storage 15 stores the new transaction data into ledger memory 16 according to an algorithm depending on a type of the distributed ledger. Moreover, storage 15 transmits and receives communication data to and from storage 15 of a different server among servers 10A, etc., and stores the aforementioned new transaction data into ledger memory 16 of this different server as well. For example, if the distributed ledger is a blockchain, storage 15 generates a block including the new transaction data. Then, after achieving synchronization of the generated block among servers 10A, etc., storage 15 stores this block into ledger memory 16.

Ledger memory 16 is a memory device that stores the distributed ledger. The distributed ledger stored in ledger memory 16 stores at least one piece of transaction data, and is managed to be less subject to falsification by taking advantage of characteristics of a hash value for example (described below).

The distributed ledger stored in ledge memory 16 stores beforehand reward information specifying a reward amount that is to be offered for each of at least one participant and that has a tendency to decrease with a later sign-up timing of the at least one participant.

The distributed ledger is a blockchain for example, and the present embodiment describes such a case. However, a distributed ledger based on a different algorithm (such as IOTA or hashgraph) may be adopted. Note that the distributed ledger may or may not execute a consensus algorithm (such as Practical Byzantine Fault Tolerance [PBFT], Proof of Work [PoW], or Proof of Stake [PoS]) to store new data. Examples of distributed ledger technology that executes no consensus algorithm include Hyperledger Fabric.

Controller 13 is a processor that determines whether a goal of the crowdfunding project is achieved and that controls processing related to funding and reward offering. Controller 13 receives a goal condition of the crowdfunding and information about reward, from terminal 41 through solicitation transaction. Moreover, controller 13 receives a sign-up for funding from terminals 50 and 51 through sign-up transaction. Controller 13 determines whether the goal condition of the crowdfunding is satisfied, and then outputs information indicating a result of this determination.

Furthermore, controller 13 controls processing related to the crowdfunding, based on the result of the determination. More specifically, if the crowdfunding project is successful, controller 13 performs: processing, such as making a notification; fund payment processing through payment transaction data; processing of determining a reward amount; and reward offering processing through transaction data for reward offering (this data is also referred to as reward offering transaction data or second transaction data).

To be more specific, controller 13 determines a reward amount for each of the at least one participant based on the timing at which the sign-up transaction data is received, by reference to the reward information. Then, if determining that the goal condition of the crowdfunding is satisfied, controller 13 stores reward offering transaction data indicating that the reward amount based on the aforementioned determination is to be offered to each of the at least one participant, into the distributed ledger via processor 11.

There are a plurality of timings at which the reward amount to be offered may be determined. For example, controller 13 determines the reward amount whenever a sign-up is received from terminal 50 for instance. To be more specific, controller 13 determines the reward amount within a predetermined time period of receiving the sign-up transaction data from terminal 51 for instance. The predetermined time period is about a few seconds to a few minutes. Here, controller 13 may notify the participant of the reward amount based on the determination within the predetermined time period of receiving the sign-up transaction data. This allows the timings of calculating the reward amounts to be temporally distributed and thereby is useful in distributing a processing load of the server.

Controller 13 may determine the reward amount after determining that the goal condition of the crowdfunding is satisfied. In this case, a more appropriate reward amount can be determined by, for example, changing the reward information in view of an overall status of the crowdfunding.

A part or a whole of the aforementioned processing of controller 13 may be achieved by a smart contract implemented by executing a contract code stored in ledger manager 16. However, this is not intended to be limiting. For example, the reward amount to be offered to the at least one participant may be determined by the smart contract that is executed in response to the storing of the first transaction data into the distributed ledger.

The following describes the reward to be offered to the participant.

The reward to be offered to the participant is determined according to the timing at which the participant signs up, based on the reward information included in the solicitation transaction data. For example, the reward information is a function or a table that specifies the reward amount.

FIG. 3 illustrates a first example of the reward information according to Embodiment 1. FIG. 3 illustrates an example of the reward information that specifies the reward amount using a function.

In FIG. 3, a horizontal axis represents sign-up timing x, and a vertical axis represents reward amount F (x) at timing x. More specifically, timing x indicates an ordinal number in a sequence (that is, an ordinal number indicating a position of this sign-up for the project in a sequential order). The present embodiment describes this case. However, timing x may be a time instead (such as a time elapsed from the start of solicitation for the project).

Function F (x) has a tendency to decrease with an increase of x in principle. In other words, the reward amount has a tendency to decrease with a later sign-up timing. More specifically, function F (x) decreases monotonically with respect to x. Here, function F (x) may include an interval in which the value is maintained with respect to a change of x. Moreover, function F (x) may exceptionally increase with an increase of x. This case is described in detail in Embodiment 2 below.

Controller 13 determines the reward amounts as follows through calculation using function F (x) that is the reward information as illustrated in FIG. 3. Controller 13 determines F (1), that is, E1, as the reward amount of the participant who is the first to sign up. Controller 13 also determines F (2), that is, E2, as the reward amount of the participant who is the second to sign up. Controller 13 determines F (N), that is, zero, as the reward amount of the participant who is the N-th to sign up.

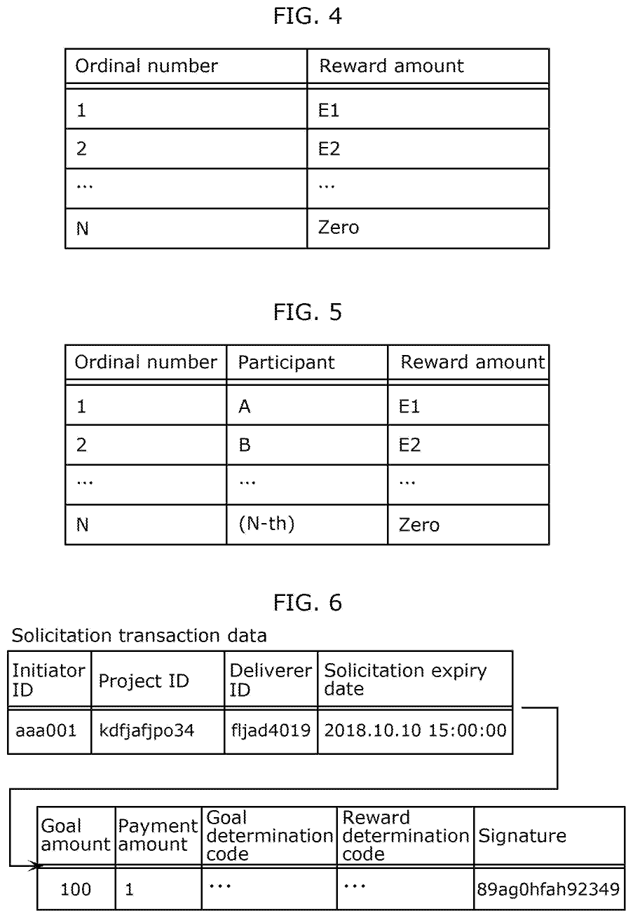

FIG. 4 illustrates a second example of the reward information according to Embodiment 1. FIG. 4 illustrates an example of the reward information that specifies the reward amount using a table.

The table illustrated in FIG. 4 indicates an ordinal number of the sign-up in association with a reward amount of a participant corresponding to this sign-up. In this table, the reward amount also has a tendency to decrease with a later sign-up timing in principle. More specifically, the reward amount decreases monotonically with respect to the ordinal number. Here, the reward amount may include an interval in which the value is maintained with respect to a change of the ordinal number. Moreover, the reward amount may exceptionally increase with a later ordinal number. This case is described in detail in Embodiment 2 below.

For example, the reward amount of the participant who is the first to sign up corresponds to E1, and the reward amount of the participant who is the second to sign up corresponds to E2. Moreover, the reward amount of the participant who is the N-th to sign up corresponds to zero.

Controller 13 determines the reward amounts as follows by reference to the table that is the reward information as illustrated in FIG. 4. By reference to the table, controller 13 determines E1 as the reward amount of the participant who is the first to sign up and also determines E2 as the reward amount of the participant who is the second to sign up. Controller 13 determines zero as the reward amount of the participant who is the N-th to sign up.

As illustrated in FIG. 3 and FIG. 4, controller 13 determines the reward amount that increases with an earlier timing of sign-up. This is useful in encouraging a participant to sign up at an even earlier timing.

FIG. 5 illustrates an example of a recording table of reward amounts according to Embodiment 1. When controller 13 determines the reward amount, the recording table records this determined reward amount.

FIG. 5 illustrates an example of a recording table of the reward amounts determined by reference to the reward information illustrated in FIG. 3 or FIG. 4.

To be more specific, the recording table illustrated in FIG. 5 indicates that: E1 is determined as the reward amount of participant A who is the first to sign up; and that E2 is determined as the reward amount of participant B who is the second to sign up.

If the reward amount is determined at a timing of receiving the sign-up transaction data from, for example, terminal 50, the recording table records the participant in association with the reward amount sequentially whenever the sign-up transaction data is received. In contrast, if the reward amounts are determined at a timing when the project achieves success, the recording table records all the participants in association with the respective reward amounts after the project achieves success.

The recording table may be recorded in a memory or a storage used by controller 13. Alternatively, the recording table may be recorded using the distributed ledger. If the distributed ledger is used, details updated from an initial recording table are recorded as a history into the distributed ledger. In this case, a latest recording table may be recorded into the memory or the storage.

Hereafter, the various kinds of transaction data stored by processor 11 into the distributed ledger are described. The various kinds of transaction data include (1) solicitation transaction data, (2) sign-up transaction data, (3) funding transaction data, (4) reward offering transaction data, (5) goal determination transaction data, and (6) reward request transaction data.

### (1) Solicitation Transaction Data

FIG. 6 schematically illustrates solicitation transaction data according to Embodiment 1. When a crowdfunding project is started, the solicitation transaction data is generated by terminal 41 and transmitted to servers 10A etc.

As illustrated in FIG. 6, the solicitation transaction data includes an initiator ID, a project ID, a deliverer ID, a solicitation expiry date, a goal amount, a payment amount, a goal determination code, a reward determination code, and a signature.

The initiator ID is an identifier that uniquely identifies the initiator who solicits funding for the project.

The project ID is an identifier that uniquely identifies the project.

The deliverer ID is an identifier that uniquely identifies the deliverer.

The solicitation expiry date is information indicating an expiry date of solicitation for the project, or more specifically, indicating an expiry date of the solicitation period.

The goal amount is information indicating a goal fund amount aimed by the initiator for the project, or more specifically, indicating the number of tokens.

The payment amount is information indicating the number of tokens to be paid by the participant for the project. If the number of tokens to be paid by the participant for the project is not prescribed, the payment amount is not to be specified.

The goal determination code is a smart contract code that determines whether the goal of the project is achieved.

The reward determination code is a smart contract code that determines the reward amounts when the project is successful.

The signature is an electronic signature added by the device or person that generates the solicitation transaction data.

The solicitation transaction data illustrated in FIG. 6 is used by the initiator having the initiator ID “aaa001” for funding solicitation for the project having the project ID “kdfjafjpo34”. For this project, the deliverer has the deliverer ID “fljad4019” and the solicitation expiry date is “2018. 10. 10 15:00:00”. Moreover, the goal amount is “100” tokens, and the payment amount is “1” token. The signature is an electronic signature of the initiator.

### (2) Sign-up Transaction Data

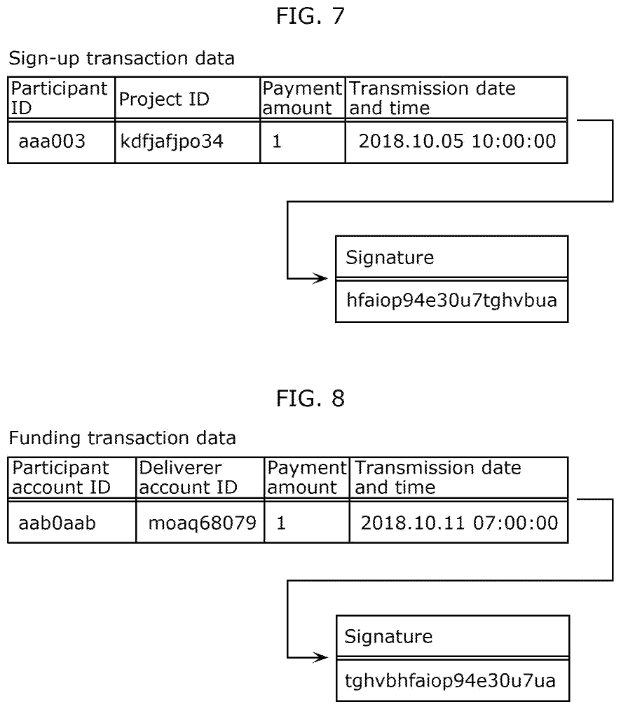

FIG. 7 schematically illustrates sign-up transaction data according to Embodiment 1. When a participant signs up for the funding for the project, the sign-up transaction data is generated by the terminal of the participant who signs up (for example, terminal 50 of participant U3) and transmitted to servers 10A etc.

As illustrated in FIG. 7, the sign-up transaction data includes a participant ID, a project ID, a payment amount, a transmission date and time, and a signature.

The participant ID is an identifier that uniquely identifies the participant who signs up for the funding.

The project ID is an identifier that uniquely identifies the project related to this sign-up.

The payment amount is information indicating the number of tokens to be paid by the participant for the sign-up.

The transmission date and time is information indicating a transmission date and time of the sign-up transaction data.

The signature is an electronic signature added by the device or person that generates the sign-up transaction data.

The sign-up transaction data illustrated in FIG. 7 is used by the participant having the participant ID “aaa003” for the sign-up for the funding for the project having the project ID “kdfjafjpo34”. For this sign-up, the payment amount is “1” token and the transmission date and time of this sign-up transaction data is “2018. 10. 05 10:00:00”. The signature is an electronic signature of the participant.

### (3) Funding Transaction Data

FIG. 8 schematically illustrates funding transaction data according to Embodiment 1. The funding transaction data is generated by servers 10A etc. for funding from the participant to the deliverer, in response to the success of the funding by the project. The funding transaction data may be generated by the terminal of the participant (terminal 50 of participant U3, for example) and transmitted to servers 10A etc.

As illustrated in FIG. 8, the funding transaction data includes a participant account ID, a deliverer account ID, a payment amount, a transmission date and time, and signature.

The participant account ID is an identifier that uniquely identifies the participant who provides funding.

The deliverer account ID is an identifier that uniquely identifies the deliverer who receives the funding.

The payment amount is information indicating the number of tokens to be provided through the funding transaction data.

The transmission date and time is information indicating the transmission date and time of the funding transaction data.

The signature an electronic signature added by the device or person that generates the funding transaction data.

The funding transaction data illustrated in FIG. 8 is used for providing a fund (token) from the participant account having the participant account ID “aab0aab” to the deliverer account having the deliverer account ID “moaq68079”. The payment about is “1” token, and the transmission date and time of this funding transaction data is “2018. 10. 11 07:00:00”. The signature is an electronic signature of the participant.

### (4) Reward Offering Transaction Data

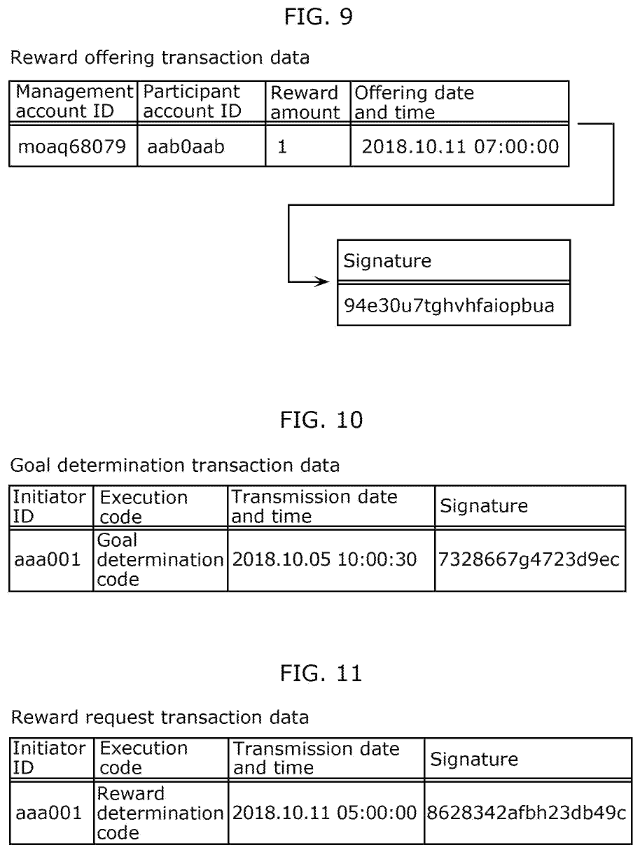

FIG. 9 schematically illustrates reward offering transaction data according to Embodiment 1. The reward offering transaction data is generated by servers 10A etc. for reward offering, in response to the success of the funding by the project. The reward offering transaction data may be generated by terminal 40 of initiator U2 and transmitted to servers 10A etc.

As illustrated in FIG. 9, the reward offering transaction data includes a management account ID, a participant account ID, a reward amount, an offering date and time, and a signature.

The management account ID is an identifier that uniquely identifies the crowdfunding management account. The management account ID indicates a reward offering source.

The participant account ID is an identifier that uniquely identifies the participant who receives the reward offering.

The reward amount is information indicating the number of tokens to be provided through the reward offering transaction data.

The offering date and time is information indicating the date and time of the reward offering completed by storing the reward offering transaction data.

The signature an electronic signature added by the device or person that generates the reward offering transaction data.

The reward offering transaction data illustrated in FIG. 9 is used for offering a reward (token) from the management account having the management account ID “moaq68079” to the participant account having the participant account ID “aab0aab”. The reward amount is “1” token and the date and time of the reward offering through this reward offering transaction data is “2018. 10. 11 07:00:00”. The signature is an electronic signature of the manager.

(5) Goal determination Transaction Data

FIG. 10 schematically illustrates goal determination transaction data according to Embodiment 1. The goal determination transaction data is generated by terminal 41 to cause servers 10A etc. to determine whether a goal of the funding project is achieved.

As illustrated in FIG. 10, the goal determination transaction data includes an initiator ID, an execution code, a transmission date and time, and a signature.

The initiator ID is an identifier that uniquely identifies the initiator.

The execution code is information indicating a smart contract code executed for determining whether the funding goal is achieved.

The transmission date and time is information indicating the date and time when the goal determination transaction data is transmitted.

The signature is an electronic signature added by the device or person that generates the goal determination transaction data.

The goal determination transaction data illustrated in FIG. 10 is used by the initiator having the initiator ID “aaa001” to cause servers 10A etc. to determine through “goal determination code” whether the funding goal is achieved. The transmission date and time of this goal determination transaction data is “2018. 10. 05 10:00:30”. The signature is an electronic signature of the initiator.

### (6) Reward Request Transaction Data

FIG. 11 schematically illustrates reward request transaction data according to Embodiment 1. The reward request transaction data is generated by terminal 41 to cause servers 10A etc. to determine the reward amount.

As illustrated in FIG. 11, the reward request transaction data includes an initiator ID, an execution code, a transmission date and time, and a signature.

The initiator ID is an identifier that uniquely identifies the initiator.

The execution code is information indicating a smart contract code executed to determine the reward amount.

The transmission date and time is information indicating the date and time when the reward request transaction data is transmitted.

The signature is an electronic signature added by the device or person that generates the reward request transaction data.

The reward request transaction data is used by the initiator having the initiator ID “aaa001” to cause servers 10A etc. to determine the reward amount through “reward determination code”. The transmission date and time of this reward request transaction data is “2018. 10. 11 05:00:00”. The signature is an electronic signature of the initiator.

The following describes the processing performed by servers 10A etc. and system-wide processing performed by fund management system 1 with reference to four cases. These four cases are different in timing of determining the reward amount and in reward offering manner.

### (1) Case of Determining Reward Amount for Each Sign-Up and Issuing and Offering New Token as Reward

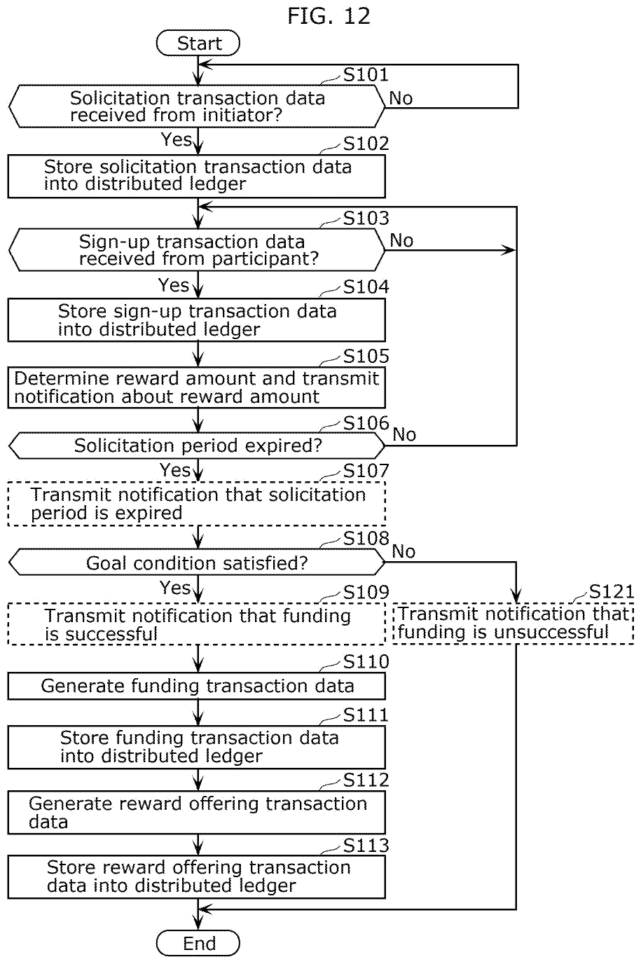

FIG. 12 is a flowchart illustrating a first case of processing performed by servers 10A etc. according to Embodiment 1.

Terminal 40 of deliverer U1 sets a condition for the crowdfunding project and transmits the condition to terminal 41 beforehand. This condition includes the solicitation expiry date, the goal amount, and the payment amount. Terminal 41 generates the solicitation transaction data including this condition and transmits the generated solicitation transaction data to servers 10A etc.

As illustrated in FIG. 12, processor 11 determines whether the solicitation transaction data is received from terminal 41 of initiator U2 in Step S101. If determining that the solicitation transaction data is received (Yes in Step S101), processor 11 proceeds to Step S102. Otherwise (No in Step S101), processor 11 executes Step S101 again. More specifically, processor 11 waits at Step S101 until the solicitation transaction data is received. Note that the solicitation transaction data includes the goal determination code and the reward determination code.

In Step S102, processor 11 stores the solicitation transaction data received in Step S101 into the distributed ledger by providing this solicitation transaction data to ledger manager 12. Moreover, processor 11 transmits the solicitation transaction data to other servers 10B etc. so that the solicitation transaction data is stored into all the distributed ledgers of servers 10A etc.

In Step S103, processor 11 determines whether the sign-up transaction data is received from terminal 41 of participant U3 for instance. If receiving the sign-up transaction data (Yes in Step S103), processor 11 proceeds to Step S104. Otherwise (No in Step S103), processor 11 executes Step S103 again. More specifically, processor 11 waits at Step S103 until the sign-up transaction data is received.

In Step S104, processor 11 stores the sign-up transaction data received in Step S103 into the distributed ledger by providing this sign-up transaction data to ledger manager 12. Moreover, processor 11 transmits the sign-up transaction data to other servers 10B etc. so that the solicitation transaction data is stored into all the distributed ledgers of servers 10A etc.

In Step S105, controller 13 determines the reward amount to be offered to the participant who is the transmission source of the sign-up transaction data received in Step S103. The determination of the reward amount is made by executing the reward determination code included in the sign-up transaction data received in Step S101. Moreover, controller 13 may notify the participant of the determined reward amount.

In Step S106, controller 13 determines whether the solicitation period is expired. Whether the solicitation period is expired is determined by determining whether the solicitation expiry date included in the solicitation transaction data received in Step S101 is reached. If determining that the solicitation period is expired (Yes in Step S106), controller 13 proceeds to Step S107. Otherwise (No in Step S106), controller 13 proceeds to Step S103.

In Step S107, controller 13 notifies participant U3, or more specifically terminal 50, that the solicitation period is expired. Note that Step S107 may not be executed.

In Step S108, controller 13 determines whether the goal condition of the crowdfunding project is satisfied. Whether the goal condition is satisfied is determined by executing the goal determination code included in the solicitation transaction data received in Step S101. If determining that the goal condition is satisfied (Yes in Step S108), controller 13 proceeds to Step S109. Otherwise (No in Step S108), controller 13 proceeds to Step S121.

In Step S109, controller 13 notifies participant U3, or more specifically terminal 50, that the funding is successful. Note that Step S109 may not be executed.

In Step S110, controller 13 generates the funding transaction data. The funding transaction data indicates that the fund is provided from the participant to the deliverer.

In Step S111, controller 13 stores the funding transaction data generated in Step S110 into the distributed ledger by providing this funding transaction data to ledger manager 12. Moreover, controller 13 transmits the funding transaction data to other servers 10B etc. so that the funding transaction data is stored into all the distributed ledgers of servers 10A etc.

In Step S112, controller 13 generates the reward offering transaction data. The reward amount determined in Step S105 is written into the reward offering transaction data generated. The reward offering transaction data indicates that the token issued as a reward corresponding to the reward amount determined in Step S105 is offered to the participant from the crowdfunding management account.

In Step S113, controller 13 stores the reward offering transaction data generated in Step S112 into the distributed ledger by providing this reward offering transaction data to ledger manager 12. Moreover, controller 13 transmits the reward offering transaction data to other servers 10B etc. so that the reward offering transaction data is stored into all the distributed ledgers of servers 10A etc.

In Step S121, controller 13 notifies participant U3, or more specifically terminal 50, that the funding is unsuccessful. Note that Step S121 may not be executed.

After Step S113 or S121, a series of processes illustrated in FIG. 12 ends.

Next, the system-wide processing of fund management system 1 is described.

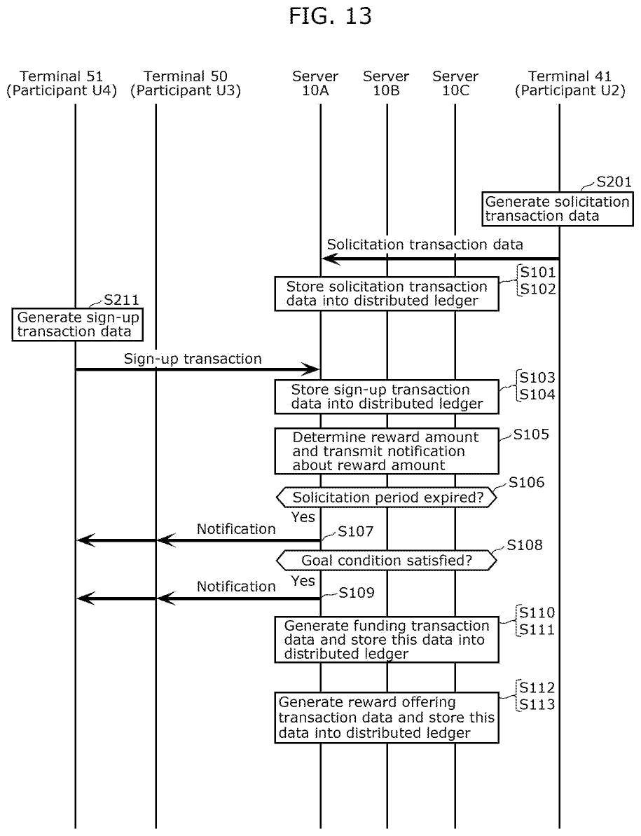

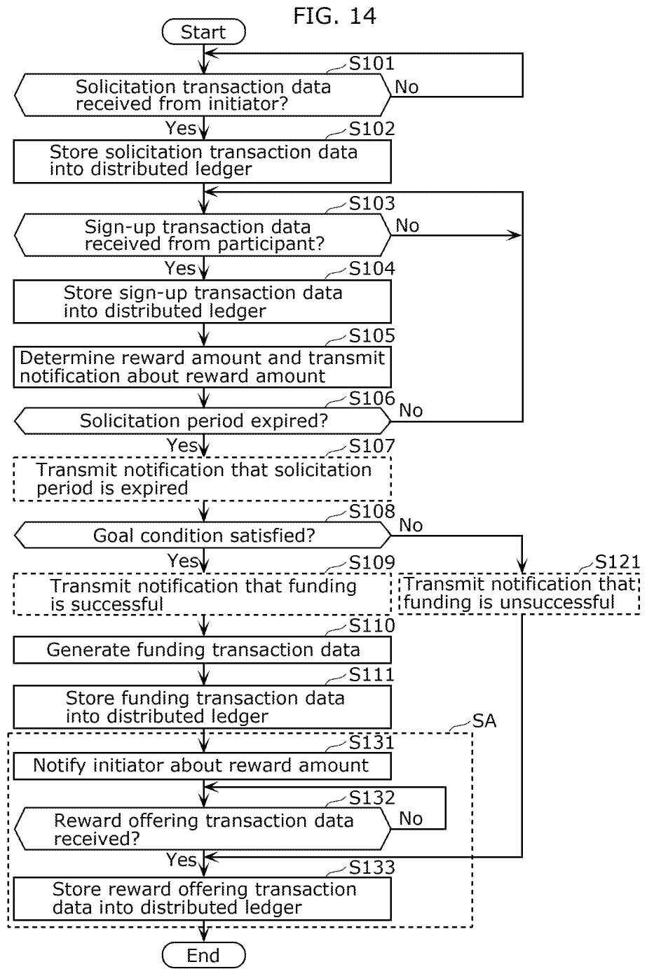

FIG. 13 is a sequence corresponding to FIG. 12 and illustrates system-wide processing of fund management system 1. FIG. 13 illustrates the system-wide processing performed by fund management system 1 if the project is successful. Note that the same processes as in the flowchart of FIG. 12 are assigned the same step numbers as in FIG. 12 and are not described in detail.

Terminal 40 of deliverer U1 sets a condition for the crowdfunding project and transmits the condition to terminal 41 beforehand. This condition includes the solicitation expiry date, the goal amount, and the payment amount. Terminal 41 receives the condition transmitted.

In Step S201, terminal 41 generates the solicitation transaction data based on the condition received from terminal 40. The generated solicitation transaction data includes the goal determination code and the reward determination code (see FIG. 6). Moreover, terminal 41 transmits the generated solicitation transaction data to servers 10A etc. At this time, terminal 41 may transmit the generated solicitation transaction data to one or at least two of servers 10A etc.

Servers 10A etc. receive the solicitation transaction data transmitted from terminal 41 and store this solicitation transaction data into the distributed ledgers (Steps S101 and S102).

In Step S211, terminal 51 generates the sign-up transaction data and then transmits this sign-up transaction data to servers 10A etc. At this time, terminal 51 may transmit the generated sign-up transaction data to one or at least two of servers 10A etc.

Servers 10A etc. receive the sign-up transaction data transmitted, and then store this sign-up transaction data into the distributed ledgers (Steps S103 and S104). Moreover, servers 10A etc. determine the reward amount of participant U4 owning terminal 51 that is the transmission source of the sign-up transaction data (Step S105). Upon expiry of the solicitation period, servers 10A etc. transmit a notification about the expiry of the solicitation period (Steps S106 and S107).

If the goal condition is satisfied, servers 10A etc. generate the funding transaction data used for providing the fund from the management account to the deliverer and the reward offering transaction data used for offering the reward from the management account to the participant, and then stores the generated data into the distributed ledgers (Steps S110 to S113).

(2) Case of Determining Reward Amount for Each Sign-Up and Offering Existing Token as Reward (Case where Server 10A Autonomously Performs the Goal Determination and the Reward Offering)

FIG. 14 is a flowchart illustrating a second case of processing performed by servers 10A etc. according to Embodiment 1. The flowchart of FIG. 14 is different from the flowchart of FIG. 12 in steps within dashed frame SA. These steps are mainly described as follows.

After receiving the solicitation transaction data from initiator U2 (terminal 41), processor 11 and controller 13 store the funding transaction data into the distributed ledger if the crowdfunding is successful as a result of the satisfied goal condition (Steps S101 to S111).

In Step S131, controller 13 notifies initiator U2, or more specifically terminal 41, of the reward amount determined in Step S105.

In Step S132, processor 11 determines whether the reward offering transaction data is received from terminal 41 of initiator U2. If receiving the reward offering transaction data (Yes in Step S132), processor 11 proceeds to Step S133. Otherwise (No in Step S132), processor 11 executes Step S132 again. More specifically, processor 11 waits at Step S132 until the reward offering transaction data is received.

In Step S133, processor 11 stores the reward offering transaction data received in Step S132 into the distributed ledger by providing this reward offering transaction data to ledger manager 12. Moreover, processor 11 transmits the reward offering transaction data to other servers 10B etc. so that the reward offering transaction data is stored into all the distributed ledgers of servers 10A etc.

Next, the system-wide processing of fund management system 1 is described.

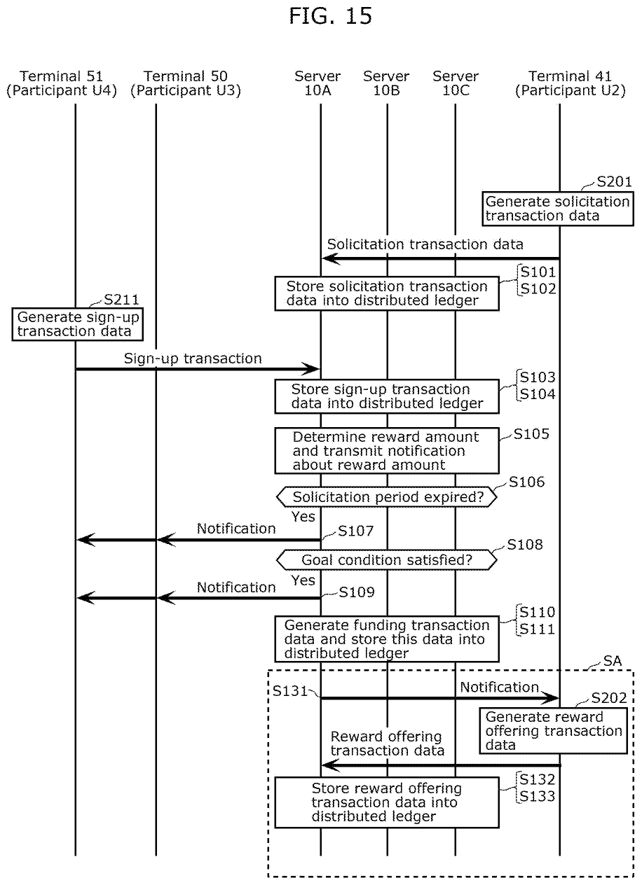

FIG. 15 is a sequence corresponding to FIG. 14 and illustrates system-wide processing performed by fund management system 1. The flowchart of FIG. 15 is different from the flowchart of FIG. 13 in steps within dashed frame SA. These steps are mainly described as follows.

If the funding is successful, fund management system 1 stores the funding transaction data into the distributed ledger (Steps S101 to S111).

In response to notification of the reward amount from server 10A to initiator U2, or more specifically terminal 41 (Step S131), terminal 41 of initiator U2 generates the reward offering transaction data and transmits this reward offering transaction data to server 10A (Step S202). Server 10A receives the reward offering transaction data and stores this reward offering transaction data into the distributed ledger (Steps S132 and S133).

(3) Case of Determining Reward Amount for Each Sign-Up and Offering Existing Token as Reward (Case of Performing the Goal Determination and the Reward Offering in Response to Instruction from Initiator)

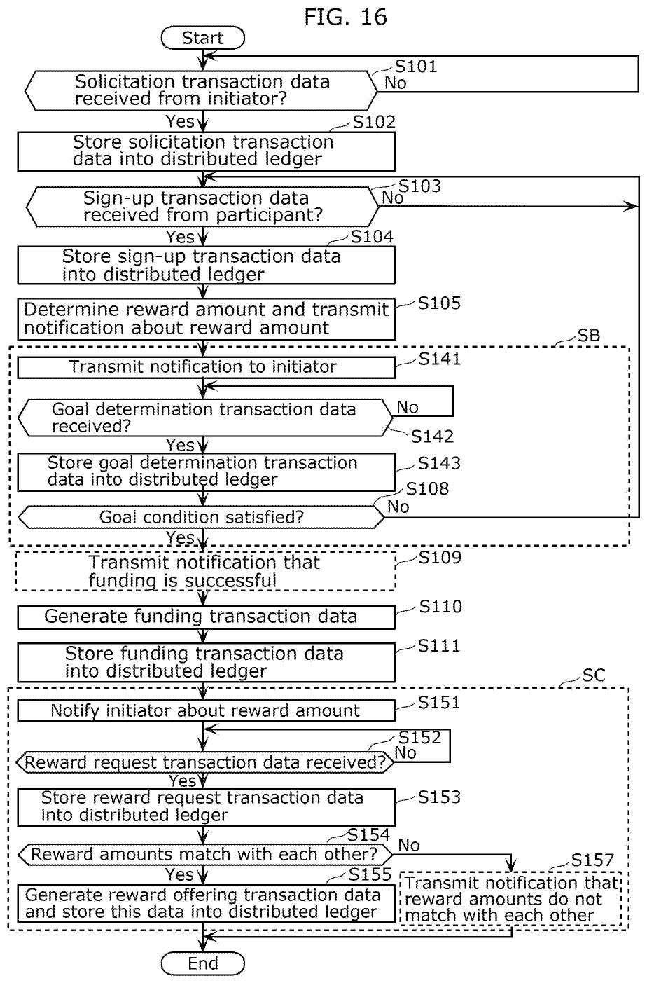

FIG. 16 is a flowchart illustrating a third case of processing performed by servers 10A etc. according to Embodiment 1. The flowchart of FIG. 16 is different from the flowchart of FIG. 12 in steps within dashed frame SB and steps within dashed frame SC. These steps are mainly described as follows.

After receiving the solicitation transaction data from terminal 41 of initiator U2 and then receiving the sign-up transaction data, processor 11 and controller 13 determine the reward amount to be offered to the participant (Steps S101 to S105).

In Step S141, processor 11 notifies the initiator of the reward amount determined in Step S105.

In Step S142, processor 11 determines whether the goal determination transaction data is received. If determining that the goal determination transaction data is received (Yes in Step S142), processor 11 proceeds to Step S143. Otherwise (No in Step S142), processor 11 executes Step S142 again. More specifically, processor 11 waits at Step S142 until the goal determination transaction data is received.

In Step S143, processor 11 stores the goal determination transaction data received in Step S142 into the distributed ledger by providing this goal determination transaction data to ledger manager 12. Moreover, processor 11 transmits the goal determination transaction data to other servers 10B etc. so that the goal determination transaction data is stored into all the distributed ledgers of servers 10A etc.

Following Step S143, controller 13 determines whether the goal condition of the crowdfunding project is satisfied (S108). At this time, controller 13 may determine as in Step S106 whether the solicitation period is expired.

After storing the funding transaction data into the distributed ledger as a result of the successful funding, processor 11 notifies initiator U2, or more specifically terminal 41, of the reward amount in Step S151.

In Step S152, processor 11 determines whether the reward request transaction data is received. If determining that the reward request transaction data is received (Yes in Step S152), processor 11 proceeds to Step S153. Otherwise (No in Step S152), processor 11 executes Step S152 again. More specifically, processor 11 waits at Step S152 until the reward request transaction data is received.

In Step S153, processor 11 stores the reward request transaction data received in Step S152 into the distributed ledger by providing this reward request transaction data to ledger manager 12. Moreover, processor 11 transmits the reward request transaction data to other servers 10B etc. so that the reward request transaction data is stored into all the distributed ledgers of servers 10A etc.

In Step S154, processor 11 determines whether the reward amount included in the reward request transaction data received in Step S152 matches the reward amount determined in Step S105. If the reward amounts match with each other (Yes in Step S154), processor 11 proceeds to Step S155. Otherwise (No in Step S154), processor 11 proceeds to Step S157.

In Step S155, processor 11 generates the reward offering transaction data, and then stores the generated reward offering transaction data into the distributed ledger by providing this reward offering transaction data to ledger manager 12. Moreover, processor 11 transmits the reward offering transaction data to other servers 10B etc. so that the reward offering transaction data is stored into all the distributed ledgers of servers 10A etc.

In Step S157, controller 13 provides a notification that the reward amounts do not match with each other. Note that Step S157 may not be executed.

Next, the system-wide processing of fund management system 1 is described.

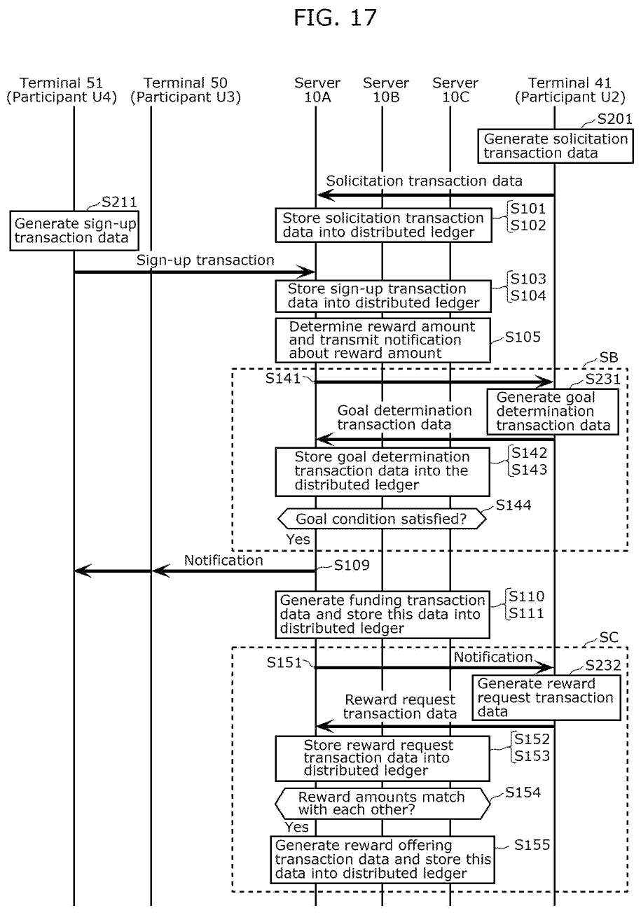

FIG. 17 is a sequence corresponding to FIG. 16 and illustrates system-wide processing performed by fund management system 1. The flowchart of FIG. 17 is different from the flowchart of FIG. 16 in steps within dashed frame SB and steps within dashed frame SC. These steps are mainly described as follows.

In response to notification of the reward amount from server 10A to terminal 41 (Step S141), terminal 41 generates the goal determination transaction data and transmits this goal determination transaction data to servers 10A etc. in Step S231. Server 10A receives the goal determination transaction data from terminal 41 and stores this goal determination transaction data into the distributed ledger (Steps S142 and S143).

After storing the funding transaction data into the distributed ledger, servers 10A etc. notify terminal 41 of the reward amount (Step S151). In response to this, terminal 41 generates the reward request transaction data in Step S232 and transmits the generated reward request transaction data to servers 10A etc. Server 10A receives the reward request transaction data from terminal 41 and stores this reward request transaction data into the distributed ledger (Steps S152 and S153). Then, server 10A stores the reward offering transaction data into the distributed ledger.

### (4) Case of Determining Reward Amount if Funding is Successful

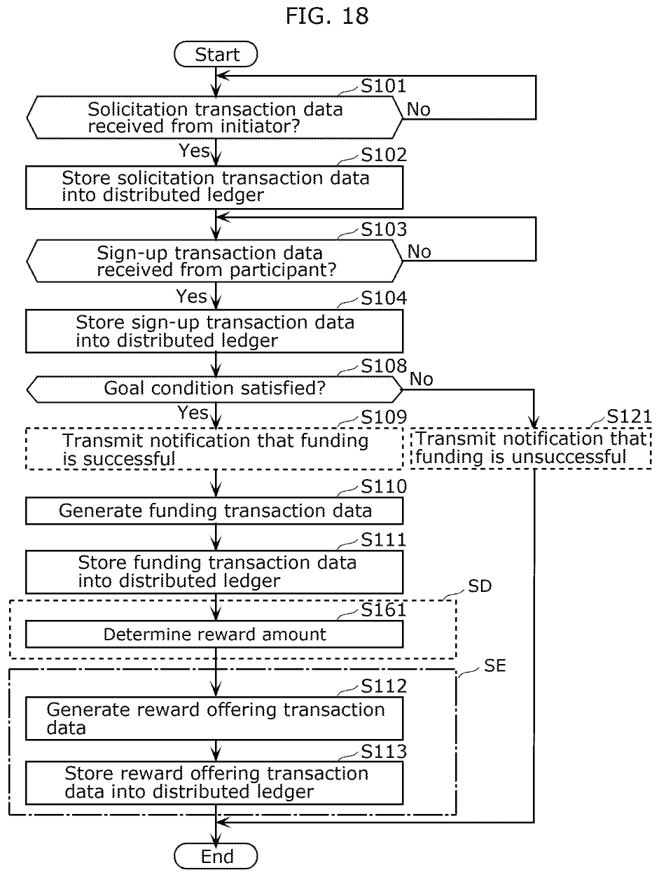

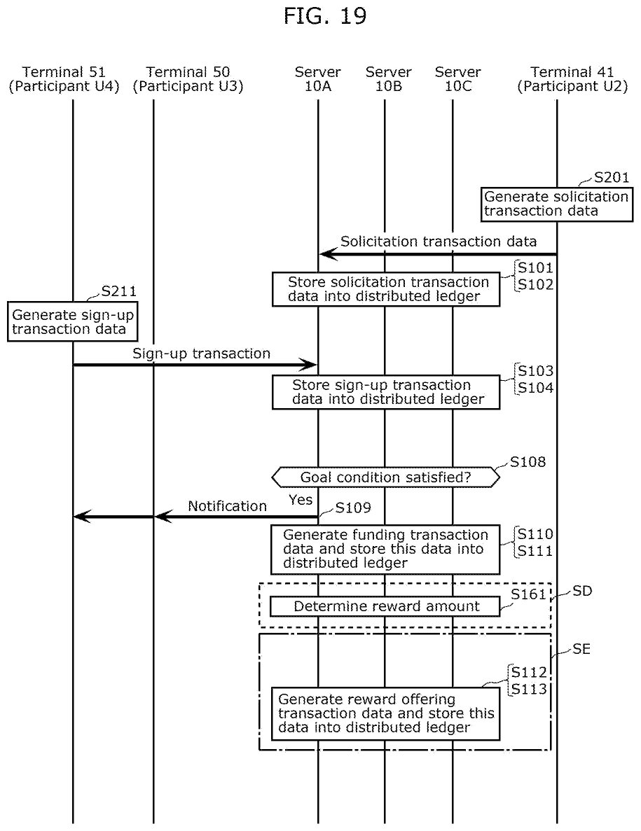

FIG. 18 is a flowchart illustrating a fourth case of processing performed by servers 10A etc. according to Embodiment 1. FIG. 19 is a sequence corresponding to FIG. 18 and illustrates system-wide processing performed by fund management system 1. The processing of servers 10A etc. and the system-wide processing of fund management system 1 are described with reference FIG. 18 and FIG. 19. FIG. 18 and FIG. 19 are different from FIG. 12 and FIG. 13 in a step within dashed frame SD. This step is mainly described as follows.

After receiving the solicitation transaction data from initiator U2 of terminal 41, processor 11 and controller 13 store the received sign-up transaction data into the distributed ledger (Steps S101 to S104). Following this, controller 13 does not determine the reward amount. To be more specific, the determination of the reward amount is restricted.

Next, controller 13 determines whether the goal condition is satisfied (Step S108). If determining that the goal condition is satisfied, controller 13 generates the funding transaction data and stores this generated funding transaction data into the distributed ledger (Steps S110 and S111). When this determination is made, controller 13 may determine as in Step S106 whether the solicitation period is expired.

In Step S161, controller 13 determines the reward amount to be offered to the participant who is the transmission source of the sign-up transaction data received in Step S103. The determination of the reward amount is made by executing the reward determination code included in the sign-up transaction data received in Step S101.

After this, controller 13 generates the reward offering transaction data based on the reward amount determined in Step S161 and stores this generated reward offering transaction data into the distributed ledger (Steps S112 and S113).

Here, Steps S112 and S113 (the steps within dashed-dotted frame SE) may be substituted by the steps within dashed frame SA (that is, Steps S131 to S133) as described in (2) above. Alternatively, Steps S112 and S113 may be substituted by the steps within dashed frame SC (that is, Steps S151 to S157) as described in (3) above.

As described thus far, the control method according to the present embodiment encourages a participant, who intends to obtain the highest possible reward amount, to sign up at an earlier timing. This enables the crowdfunding to achieve success sooner. After this early success of the crowdfunding, power consumption for operating the server to manage the crowdfunding can be reduced. Thus, the control method according to the present disclosure is capable of reducing the power consumption of the fund management system for crowdfunding.

Moreover, the reward amount is determined within a predetermined time period of receiving the sign-up transaction data. This allows the processing timings to be distributed and thereby is useful in distributing a processing load of the server. Moreover, this can avoid a momentary peak of power consumption that may arise. Hence, the control method according to the present disclosure is capable of temporally distributing the processing load and thereby reducing the power consumption of the fund management system for crowdfunding.

Moreover, the notification of the reward amount to the participant allows the participant to know the reward to be offered to the participant. This further motivates the participant to newly sign up. Thus, the power consumption for operating the server to manage the crowdfunding can be further reduced. Hence, the control method according to the present disclosure is capable of reducing the power consumption of the fund management system for crowdfunding.

Furthermore, the reward amounts of all the participants are determined after the crowdfunding achieves success. Thus, more appropriate reward amounts can be determined in view of an overall status of the crowdfunding. Hence, the control method according to the present disclosure is capable of reducing the power consumption of the fund management system for crowdfunding.

Moreover, the distributed ledger is stored through the execution of the consensus algorithm. Hence, the control method according to the present disclosure more easily enables appropriate management of funding for the crowdfunding by the execution of the consensus algorithm.

Furthermore, the reward amount is determined early and safely without any intervention of another person or another system. Hence, the control method according to the present disclosure is capable of further reducing the power consumption of the fund management system for crowdfunding.

### Embodiment 2

The present embodiment describes a fund management system and a control method used by the fund management system that are capable of reducing power consumption of the fund management system for crowdfunding. The present embodiment particularly describes a technology that allows the crowdfunding to achieve success earlier in a period relatively near expiry of a solicitation period.

To be more specific, the reward information further specifies an additional reward amount that is to be additionally offered to a participant, among at least one participant, that signs up after a predetermined timing within a solicitation period of the crowdfunding. Then, third transaction data indicating that the additional reward amount is to be offered to the participant, among the at least one participant, that signs up after the predetermined timing is stored into the distributed ledger. Here, the determination of the additional reward amount may be made by executing a smart contract in response to the storing of the first transaction data into the distributed ledger.

Configurations of fund management system 1 and servers 10A etc. are the same as in Embodiment 1. However, operations performed by processor 11 and controller 13 are different from those performed in Embodiment 1.

More specifically, reward information included in solicitation transaction data received by controller 13 is different in the present embodiment. Moreover, a method of offering a reward based on this reward information is different in the present embodiment.

The following describes the reward information and the reward offering method.

### (1) Reward Information

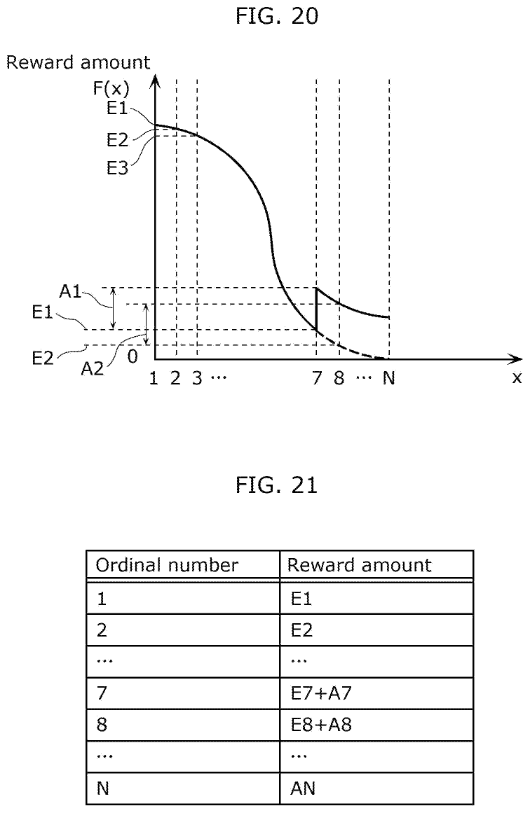

FIG. 20 illustrates a first example of reward information according to Embodiment 2. Similar to FIG. 3, the reward information illustrated in FIG. 20 specifies the reward amount using a function. Moreover, vertical and horizontal axes in FIG. 20 are the same as those in FIG. 3.

Function F (x) has a tendency to decrease with an increase of x in principle. In other words, the reward amount has a tendency to decrease with a later sign-up timing. More specifically, function F (x) decreases monotonically with respect to x. Here, function F (x) may include an interval in which the value is maintained with respect to a change of x.

Moreover, function F (x) exceptionally increases with an increase of x. To be more specific, F (x) increases with an increase of x near x=7. Furthermore, F (x) has a greater value than in FIG. 3 in an interval where x is 7 to N.

According to function F (x) in FIG. 20, the reward amount of the participant who is the first to sign up is determined as F (1), that is, E1. Moreover, the reward amount of the participant who is the second to sign up is determined as F (2), that is, E2.

Furthermore, the reward amount of the participant who is the seventh to sign up is determined as F (7), that is, E7+A7. The reward amount of the participant who is the eight to sign up is determined as F (8), that is, E8+A8. The reward amount of the participant who is the N-th to sign up is determined as F (N), that is, AN. Here, an additional amount of F (x) according to the present embodiment with respect to F (x) according to Embodiment 1, such as A7 of the reward amount of the seventh participant and A8 of the reward amount of the eighth participant, is also referred to as the additional reward amount. On the other hand, the reward amount corresponding to F (x) according to Embodiment 1 is also referred to as the basic reward amount.

Note that a predetermined timing for function F (x) illustrated in FIG. 20 corresponds to a timing for x=7.

FIG. 21 illustrates a second example of reward information according to Embodiment 2. Similar to FIG. 4, the reward information illustrated in FIG. 21 specifies the reward amounts using a table.

The table illustrated in FIG. 21 indicates an ordinal number of the sign-up in association with a reward amount of a participant corresponding to this sign-up.

For example, the reward amount of the participant who is the first to sign up corresponds to E1, and the reward amount of the participant who is the second to sign up corresponds to E2.

For example, the reward amount of the participant who is the seventh to sign up corresponds to E7+A7, and the reward amount of the participant who is the eighth to sign up corresponds to E8+A8. Moreover, the reward amount of the participant who is the N-th to sign up corresponds to AN.

Note that a predetermined timing in the table illustrated in FIG. 21 corresponds to a timing of the seventh sign-up.

### (2) Reward Offering Method

The following describes two cases of the method for offering the reward amount determined based on the reward information described above.

In a first case, the reward corresponding to the reward amount is offered through a single smart contract executed by servers 10A etc.

The smart contract in this case is the same as that executed by controller 13 according to Embodiment 1, and thus is not described in detail here.

In a second case, servers 10A etc. execute two smart contracts and the reward corresponding to the reward amount is offered through cooperation between the two smart contracts.

The second case is described in detail.

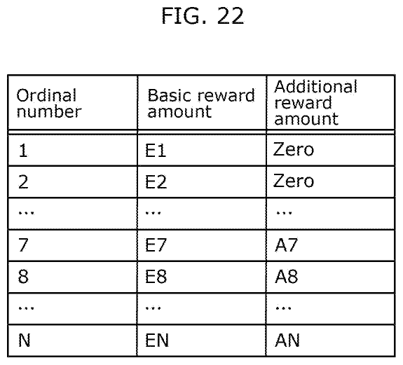

FIG. 22 illustrates reward amounts determined by the two smart contracts according to Embodiment 2. Here, one of the two smart contracts that determines the basic reward amount is also referred to as smart contract 1, and the other of the two that determines the additional reward amount is also referred to as smart contract 2.

As illustrated in FIG. 22, the basic reward amounts offered by smart contract 1 are the same as the reward amounts illustrated in FIG. 4.

The additional reward amounts offered to the first to sixth participants through smart contract 2 are zero. The additional reward amounts offered to the seventh to N-th participants are A7 to AN.

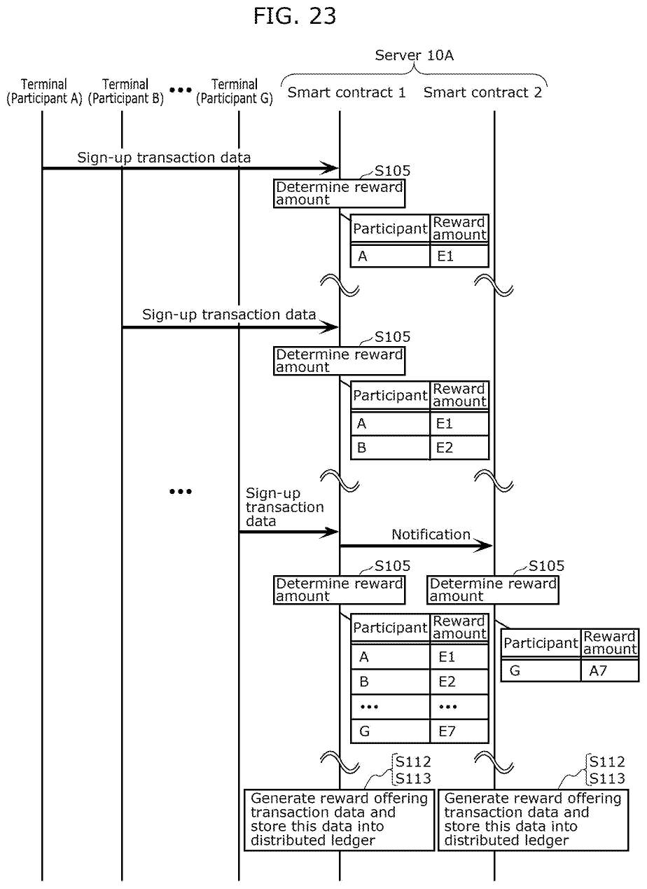

FIG. 23 is a sequence of processing executed by the two smart contracts to determine the reward amounts, according to Embodiment 2.

FIG. 23 illustrates a case where terminals of participants A, B, . . . and G sequentially transmit the sign-up transaction data to server 10A.

If participant A who is the first to sign up transmits the sign-up transaction data, this sign-up transaction data is stored into the distributed ledgers of servers 10A etc. Then, the reward amount is determined by smart contract 1 (Step S105). To be more specific, reward amount E1 is determined as the basic reward amount of participants A. At this time, smart contract 2 does not determine the additional reward amount of participant A. Here, after knowing that smart contract 1 has determined the basic reward amount, smart contract 2 may determine zero as the additional reward amount of participant A.

Next, if participant B who is the second to sign up transmits the sign-up transaction data, this sign-up transaction data is stored into the distributed ledgers of servers 10A etc. Then, the reward amount is determined by smart contract 1 (Step S105). To be more specific, reward amount E2 is determined as the basic reward amount of participants B. At this time, smart contract 2 does not determine the additional reward amount of participant B (or determines zero as the additional reward amount).

Similarly, smart contract 1 determines the basic reward amounts of the third to sixth participants.

If participant G who is the seventh to sign up transmits the sign-up transaction data, this sign-up transaction data is stored into the distributed ledgers of servers 10A etc. Then, the reward amount is determined by smart contract 1 (Step S105). To be more specific, reward amount E7 is determined as the basic reward amount of participants G. At this time, smart contract 2 obtains notification that smart contract 1 has determined the basic reward amount, and then determines A7 as the additional reward amount of participant G (Step S105).

Similarly, smart contract 1 determines the basic reward amounts of the eighth to N-th participants, and smart contract 2 determines the additional reward amounts of the eighth to N-th participants.

At this time, assume that the solicitation period is expired and that the goal condition is satisfied. In this case, smart contract 1 generates the reward offering transaction data for offering the rewards corresponding to the basic reward amounts, and stores this generated reward offering transaction data into the distributed ledger (Steps S112 and S113). Moreover, smart contract 2 generates reward offering transaction data (corresponding to third transaction data) for offering the rewards corresponding to the additional reward amounts, and stores this generated reward operation transaction data into the distributed ledger (Steps S112 and S113).

In this way, the basic reward amount and the additional reward amount are offered to each of the participants.

As described thus far, the server according to the present embodiment offers an additional reward to a participant. Thus, even after the predetermined timing in the solicitation period, a participant intends to obtain the highest possible reward amount and thus signs up as soon as possible. This further enables the crowdfunding to achieve success sooner. Thus, the control method according to the present disclosure is capable of further reducing the power consumption of the fund management system for crowdfunding.

Moreover, the additional reward amount is determined early and safely without any intervention of another person or another system. Hence, the control method according to the present disclosure is capable of further reducing the power consumption of the fund management system for crowdfunding.

### Variation 1 of Embodiments

The following describes another configuration of the fund management system, according to the present variation of Embodiments described above.

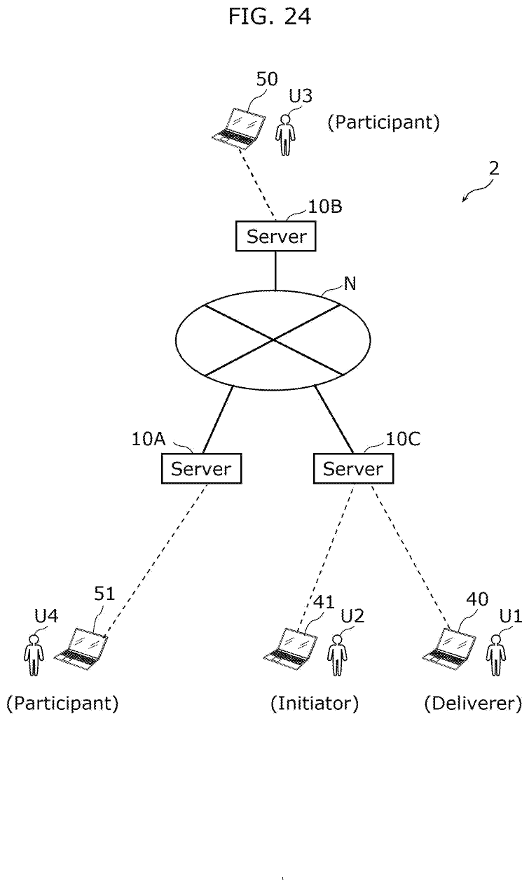

FIG. 24 is a schematic block diagram illustrating a configuration of fund management system 2 according to Variation 1 of Embodiments.

As illustrated in FIG. 24, fund management system 2 includes servers 10A, 10B, and 10C, and terminals 40, 41, 50, and 51. These devices included in fund management system 2 are communicably connected to each other via network N. Network N may use any kind of communication line or network. Examples include the Internet and a mobile phone carrier network.

In particular, servers 10A, 10B, and 10C of fund management system 2 are connected to each other via network N. Server 10A is connected to terminal 51. Server 10B is connected to terminal 50. Server 10C is connected to terminals 40 and 41.

Such configuration may be used for fund management system 2 run by a plurality of groups that have respective managed servers connected to each other via network N. For example, server 10A and terminal 51 belong to group A, server 10B and terminal 50 belong to group B, and server 10C and terminals 40 and 41 belong to group C.

Operations performed by servers 10A etc. and terminals 40 etc. are the same as those described in Embodiments above, and thus are omitted from the description.

### Variation 2 of Embodiments

The following describes another configuration of the fund management system, according to the present variation of Embodiments described above.

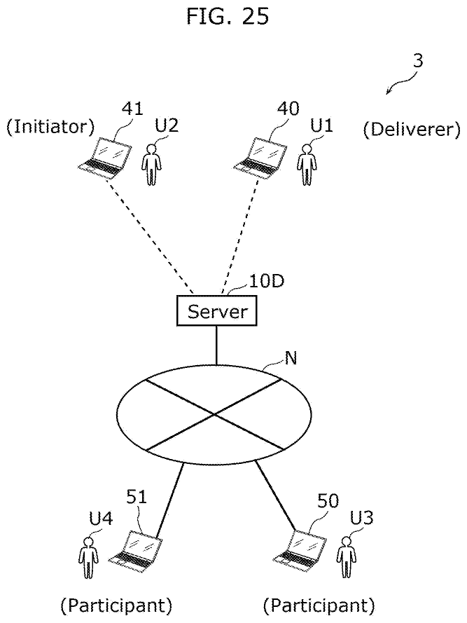

FIG. 25 is a schematic block diagram illustrating a configuration of fund management system 3 according to Variation 2 of Embodiments.

As illustrated in FIG. 25, fund management system 3 includes server 10D and terminals 40, 41, 50, and 51. The devices included in fund management system 3 are communicably connected to each other via network N. Network N may use any kind of communication line or network. Examples include the Internet and a mobile phone carrier network.

In particular, server 10D and terminals 50 and 51 of fund management system 3 are connected to each other via network N. Server 10D is connected to terminals 40 and 41. In this case, terminals 50 and 51 operate as servers 10A etc. according to Embodiments described above.

Such configuration may be used for fund management system 3 run by at least one group and at least one individual that have respective managed servers or terminals connected to each other via network N. For example, server 10D and terminals 40 and 41 belong to group D. Fund management system 3 is run by group D and individual participants U4 and U3.

Operations performed by server 10D and terminals 40 etc. are the same as those described in Embodiments above, and thus are omitted from the description.

### Variation 3 of Embodiments

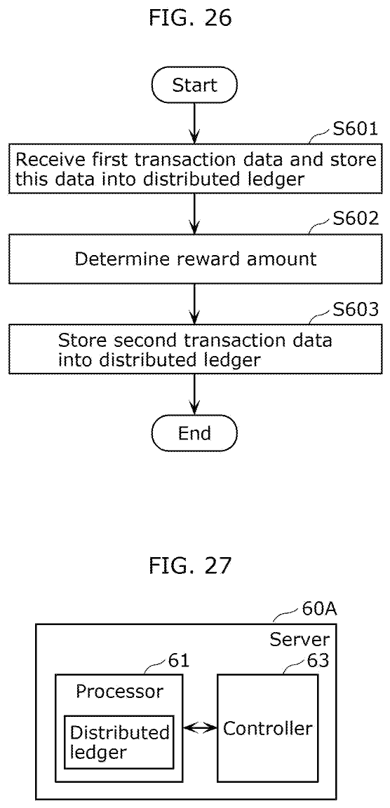

The following describes Variation 3 of Embodiments above. FIG. 26 is a flowchart illustrating processing performed by a server according to Variation 3.

As illustrated in FIG. 26, first transaction data that is transaction data related to a sign-up for crowdfunding from at least one participant is received and the first transaction data received is stored into the distributed ledger included in each of the plurality of servers in Step S601. Here, the distributed ledger stores beforehand reward information specifying a reward amount that is to be offered for each of the at least one participant and that has a tendency to decrease with a later timing of the sign-up of the at least one participant.

In Step S602, the reward amount is determined by reference to the reward information for each of the at least one participant, based on the timing at which the first transaction data is received.

In Step S603, if it is determined that the goal condition of the crowdfunding is satisfied, second transaction data that indicates that each of the at least one participant is offered a reward corresponding to the reward amount determined is stored into the distributed ledger.

This can reduce power consumption of the fund management system for the crowdfunding.

FIG. 27 is a schematic block diagram illustrating a configuration of the server according to Variation 3 of Embodiments.

The fund management system includes the plurality of servers each including the distributed ledger. As illustrated in FIG. 27, one of the plurality of servers includes processor 61 and controller 63.

Processor 61 receives first transaction data that is transaction data related to a sign-up for crowdfunding from at least one participant, and stores the received first transaction data into the distributed ledger included in each of the plurality of servers. Here, the distributed ledger stores beforehand reward information specifying a reward amount that is to be offered for each of the at least one participant and that has a tendency to decrease with a later timing of the sign-up of the at least one participant.

Controller 63 determines the reward amount by reference to the reward information for each of the at least one participant, based on the timing at which the first transaction data is received.

If it is determined that the goal condition of the crowdfunding is satisfied, processor 61 further stores second transaction data that indicates that each of the at least one participant is offered a reward corresponding to the reward amount, into the distributed ledger.

This can reduce the power consumption of the fund management system for the crowdfunding.

### Complementary Remarks

A blockchain according to Embodiments above and Variations is complementally described.

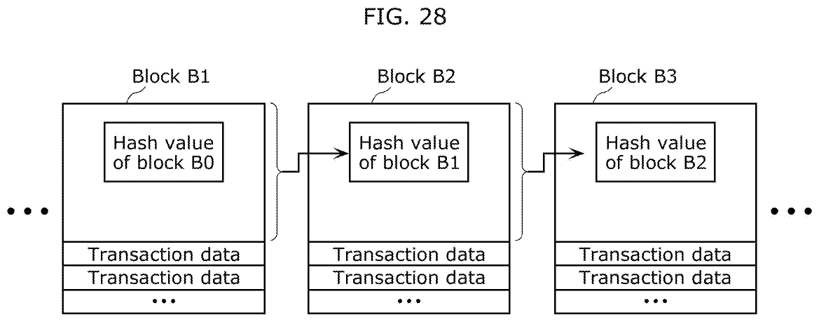

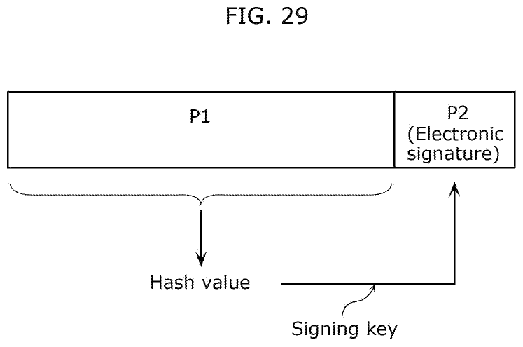

FIG. 28 illustrates a data structure of a blockchain.

A blockchain includes blocks, each being a unit of recording, and forms a chain by linking the blocks together. Each of the blocks includes a plurality of pieces of transaction data and a hash value of an immediately preceding block. To be more specific, block B2 includes a hash value of block B1 that is the immediately preceding block. Then, a hash value calculated from the plurality of pieces of transaction data included in block B2 and the hash value of block B1 is contained as the hash value of block B2 in block B3. In this way, blocks contain the information of the preceding block as the hash value, forming a chain. This effectively prevents the recorded transaction data from falsification.

If the transaction data in the past is modified, the hash value of the block is different from the value before the modification. To make the falsified block appear correct, all the subsequent blocks need to be altered. Realistically speaking, this is extremely difficult. Such characteristics of blockchains assure resistance to falsification.

FIG. 29 illustrates a data structure of transaction data.

Transaction data illustrated in FIG. 29 includes transaction data boy P1 and electronic signature P2. Transaction data body P1 is a data body included in the transaction data. Electronic signature P2 is signed using a signing key of a creator of the transaction data. More specifically, electronic signature P2 is generated through encryption using a private key of the creator.

It is substantially impossible for the transaction data including electronic signature P2 to be falsified. This prevents the transaction data body from falsification.

Moreover, in the above embodiments, the respective structural components may be implemented as dedicated hardware or may be realized by executing a software program suited to the respective structural components. Alternatively, the respective structural components may be implemented by a program executor such as a CPU or a processor reading out and executing the software program recorded in a recording medium such as a hard disk or a semiconductor memory. Here, the software for implementing the content management system and so forth in the above embodiments is a program such as that described below.

Specifically, the above program is program that causes a computer to execute a control method executed by one of a plurality of servers included in a fund management system and each including a distributed ledger. The control method includes: receiving first transaction data that is transaction data related to a sign-up for crowdfunding from at least one participant and storing the first transaction data received into the distributed ledger included in each of the plurality of servers, the distributed ledger storing beforehand reward information specifying a reward amount that is to be offered for each of the at least one participant and that has a tendency to decrease with a later timing of the sign-up of the at least one participant; determining, by reference to the reward information, the reward amount for each of the at least one participant based on a timing at which the first transaction data is received; and storing, into the distributed ledger, second transaction data that is transaction data indicating that each of the at least one participant is offered the reward amount determined in the determining, if it is determined that a goal condition of the crowdfunding is satisfied.

Although a fund management system according to one or more aspects has been described above based on exemplary embodiments, the present disclosure is not limited to the foregoing embodiments. Forms achieved by making various modifications to the above embodiments that can be conceived by those skilled in the art, as well forms achieved by combining structural components in different embodiments, so long as they do not materially depart from the spirit of the present disclosure, may be included in the one or more aspects.

### INDUSTRIAL APPLICABILITY

The present disclosure is applicable to a fund management system that manages crowdfunding.

1. A control method executed by one of a plurality of servers included in a fund management system, each of the plurality of servers including a distributed ledger, the control method comprising:
receiving first transaction data that is transaction data related to a sign-up for crowdfunding from at least one participant and storing the first transaction data received into the distributed ledger included in each of the plurality of servers, the distributed ledger storing beforehand reward information specifying a reward amount that is to be offered for each of the at least one participant and that has a tendency to decrease with a later timing of the sign-up of the at least one participant;
determining, by reference to the reward information, the reward amount for each of the at least one participant based on a timing at which the first transaction data is received; and
storing, into the distributed ledger, second transaction data that is transaction data indicating that each of the at least one participant is offered the reward amount determined in the determining, if it is determined that a goal condition of the crowdfunding is satisfied.

2. The control method according to claim 1,
wherein if the first transaction data is received from one participant among the at least one participant, the determining of the reward amount of the one participant is performed within a predetermined time period of receiving the first transaction data.

3. The control method according to claim 2, further comprising:
notifying the one participant about the reward amount determined in the determining, within a predetermined time period of receiving the first transaction data.

4. The control method according to claim 1,
wherein the determining of the reward amount of the at least one participant is performed after it is determined that the goal condition of the crowdfunding is satisfied.

5. The control method according to claim 1,
wherein the reward information further specifies an additional reward amount that is to be additionally offered to a participant, among the at least one participant, that signs up after a predetermined timing within a solicitation period of the crowdfunding, and
the control method further comprises:
storing, into the distributed ledger, third transaction data that is transaction data indicating that the additional reward amount is to be offered to the participant, among the at least one participant, that signs up after the predetermined timing.

6. The control method according to claim 1,
wherein the storing of the transaction data into the distributed ledger included in each of the plurality of servers includes storing the transaction data into the distributed ledger through execution of a consensus algorithm by each of the plurality of servers.

7. The control method according to claim 1,
wherein the determining of the reward amount for each of the at least one participant is performed using a smart contract that is executed based on the storing of the first transaction data into the distributed ledger.

8. The control method according to claim 5,
wherein the determining of the additional reward amount is performed using a smart contract that is executed based on the storing of the first transaction data into the distributed ledger.

9. A server among a plurality of servers included in a fund management system, each of the plurality of servers including a distributed ledger, the server comprising:
a processor that receives first transaction data related to a sign-up for crowdfunding from at least one participant and stores the first transaction data received into the distributed ledger, which is included in each of the plurality of servers and stores beforehand reward information specifying a reward amount that is to be offered for each of the at least one participant and that has a tendency to decrease with a later timing of the sign-up of the at least one participant; and
a controller that determines, by reference to the reward information, the reward amount for each of the at least one participant based on a timing at which the first transaction data is received,
wherein if it is determined that a goal condition of the crowdfunding is satisfied, the processor further stores, into the distributed ledger, second transaction data that indicates that each of the at least one participant is offered the reward amount determined.

10. A non-transitory computer-readable recording medium having recorded thereon a program for causing a computer to execute the control method according to claim 1.

11. A data structure to be recorded into a distributed ledger included in each of a plurality of servers of a fund management system,
wherein the data structure includes reward information specifying a reward amount that is to be offered for each of at least one participant who signs up for crowdfunding and that has a tendency to decrease with a later timing of a sign-up of each of the at least one participant, and
if the at least one participant signs up for the crowdfunding after the data structure is recorded into the distributed ledger, the data structure is used for determining the reward amount to be offered for each of the at least one participant based on the reward information.
